(19) United States
(12) Patent Application Publication
(10) Pub. No.: US 2026/0175464 A1
(43) Pub. Date: Jun. 25, 2026

(54) WORK APPARATUS

(71) Applicant: Andreas Stihl AG & Co. KG, Waiblingen (DE)

(72) Inventors: Andrea Hein, Ehningen (DE); Richard Wirt, Waiblingen (DE); Haruki Kudo, Iwate (JP); Naoya Wada, Iwate (JP)

(21) Appl. No.: 19/425,392

(22) Filed: Dec. 18, 2025

(30) Foreign Application Priority Data
Dec. 20, 2024 (DE) 10 2024 139 362.9

(51) Int. Cl. B27B 17/12

(52) U.S. Cl. CPC B27B 17/12

(57) ABSTRACT

A work apparatus includes a tool which is driven by a drive motor, a lubricant tank, a flow connection for lubricant from the lubricant tank to the tool, and a lubricant pump which is disposed in the flow connection. A switchable valve is disposed in the flow connection between the lubricant tank and the lubricant pump.

### CROSS-REFERENCE TO RELATED APPLICATIONS

This application claims priority of German patent application no. 10 2024 139 362.9, filed Dec. 20, 2024, the entire content of which is incorporated herein by reference.

### BACKGROUND

A hand-held work apparatus which has an oil pump is disclosed in US 2012/0030954. The conveyed oil is supplied to a guide bar in order to guarantee the lubrication of a saw chain, guided on the guide bar, of the hand-held work apparatus during operation.

### SUMMARY

It is an object of disclosure to provide a work apparatus that has an improved construction.

This object is, for example, achieved by a hand-held work apparatus having a drive motor; a tool configured to be driven by the drive motor; a lubricant tank; a flow connection for lubricant from the lubricant tank to the tool; a lubricant pump disposed in the flow connection; and, a switchable valve disposed in the flow connection between the lubricant tank and the lubricant pump.

It has been demonstrated that lubricant can leak at the lubricant pump when the work apparatus is not in operation. Lubricant can leak in particular in the case of an unfavorable storage position and a relatively long storage time and in particular when the lubricant tank is of a closed configuration and the work apparatus is exposed to temperature fluctuations. This is undesirable because the work apparatus and a storage surface of the work apparatus can be soiled as a result.

In order to limit the amount of lubricant that can leak from the work apparatus when the work apparatus is not in operation, it is provided to dispose a switchable valve in the flow connection between the lubricant tank and the lubricant pump. In particular, the valve has at least an opened position and a closed position, between which the valve is able to switch. It can be provided that the valve can also be moved to partially opened intermediate positions. When the valve is closed, lubricant can no longer makes its way from the lubricant tank to the lubricant pump and from there into the environment.

According to various embodiments, when the lubricant tank is of a closed configuration and pressure is built up in the lubricant tank due to temperature fluctuations, lubricant can be squeezed out of the lubricant tank by way of the lubricant pump. Therefore, the valve is particularly advantageous for work apparatuses, the lubricant tank of which is of a closed configuration and does not have any venting or breathing function, for example by way of a corresponding overpressure or vacuum valve.

According to various embodiments, the valve is electrically actuated. As a result, it can be easily achieved that the valve is open during operating and closed when the work apparatus is not in operation.

According to various embodiments, the valve has an actuator made from a shape memory alloy. An actuator made from a shape memory alloy can be constructed in such a way that closing of the valve takes place at a desired closing temperature. An actuator made from a shape memory alloy can be configured with low weight. An actuator made from a shape memory alloy can be configured in such a way that the electricity requirement is comparatively low. In particular, the electricity requirement is lower than with an electromagnetic actuator. Alternatively, the valve can also have another actuator, for example an electromagnetic actuator.

A valve which has an actuator made from a shape memory alloy can be switched solely by virtue of the ambient temperature, without any additional electrical supply. In order to influence the switching characteristics of the valve, the valve, in particular the actuator made from the shape memory alloy, can be additionally heated for switching. For this purpose, in particular, electric current can be directed through at least part of the actuator.

According to various embodiments, the actuator is configured in such a way that it can be heated by current flow through the actuator in less than 10 seconds, in particular less than 5 seconds, in particular 1 to 2 seconds, such that the actuator is deformed and moves a valve element of the valve to the opened position or enables the valve element to be adjusted to the opened position by another actuating element, for example a spring. The actuator is in particular configured in such a way that it cools down after the current flow has been interrupted in less than 20 seconds, in particular less than 10 seconds, in particular 3 to 7 seconds, such that the actuator resets the valve element to the closed position or is reset to the closed position by a restoring element. The time durations specified relate in particular to an ambient temperature of 20° C.

Alternatively or additionally, after putting the work apparatus in operation, the actuator can be heated by a heating apparatus in order to rapidly open the valve. During operation, the actuator can additionally or exclusively be heated by a component of the work apparatus, in particular a component of the drive motor. In particular, the current supply is reduced or switched off when components of the work apparatus, in particular a drive motor of the work apparatus, have been sufficiently heated in order to keep the valve open by virtue of the waste heat created. Alternatively or additionally, a locking apparatus or snap-fit device can be provided which mechanically locks the valve in the open position. The drive motor is in particular an internal combustion engine, and the component of the drive motor by which the actuator is heated is an exhaust muffler or a cylinder of the drive motor.

According to various embodiments, when the valve has an actuator made from a shape memory alloy, it can be provided that the valve closes when undershooting a closing temperature. The closing temperature is in particular below the temperature prevailing at the valve in the usual operation of the work apparatus. In particular, the closing temperature is from 55° C. to 70° C. When the work apparatus is not in operation, reaching these temperatures is usually possible only in exceptional cases at extreme conditions, such as in a vehicle parked in the sun in summer, for example. At usual ambient temperatures and under usual conditions, the valve is closed and lubricant cannot leak from the lubricant tank.

According to various embodiments, it is provided that the actuator of the valve is actively heated, for example by energizing. A heating element for the actuator can also be provided. After exceeding an opening temperature, the actuator opens the valve or initiates the opening of the valve by way of an actuating element, for example a spring. The opening temperature can in particular be 55° C. to 70° C. The opening temperature can in particular correspond approximately to the closing temperature. It can also be provided that the closing temperature is below the opening temperature. Closing the valve and maintaining the valve in the closed state takes place in particular without supplying external energy, such as current, for example. As a result, the valve can be reliably kept closed even over long storage periods.

According to various embodiments, the valve is connected in a heat-conducting manner to the drive motor. Often, the drive motor represents a substantial heat source of a hand-held work apparatus. Due to the heat-conducting connection between the valve and the drive motor, the actuator can be rapidly heated after putting the work apparatus into operation. As a result, a short interval between putting the work apparatus into operation and opening the valve can be achieved. As a result, sufficient lubrication of the tool can be easily achieved even shortly after putting the work apparatus into operation. Additionally, a heating apparatus for the valve or energizing the valve can be provided in order to shorten the time until the valve opens. The heating apparatus is in particular activated when putting the work apparatus into operation, for example for a predefined interval or until a predefined temperature is reached.

According to various embodiments, the valve is at least partially disposed in a pump housing of the lubricant pump. This results in a compact construction.

According to various embodiments, the valve has a valve housing. In particular, the valve housing is at least partially formed by a pump housing of the lubricant pump. A simple, compact construction can be achieved as a result. In an alternative variant of embodiment, it is provided that the valve is disposed completely in the pump housing.

According to various embodiments, the valve is connected to the drive motor in a heat-conducting manner by way of the pump housing of the lubricant pump. A heat-conducting connection between the valve and the drive motor can be easily established by way of the pump housing, in particular when the lubricant pump is disposed directly on the drive motor and/or is connected to the latter in a heat-conducting manner. This results in a simple construction.

According to various embodiments, the valve is configured in such a way that lubricant cannot leak at the valve. In particular, the valve has a membrane on which a valve element of the valve is held.

The membrane is held in a manner clamped on its circumference in particular in a sealing manner between two housing parts of the valve.

According to various embodiments, the membrane delimits a lubricant chamber through which the flow connection leads. In particular, the actuator is disposed on the side of the membrane that faces away from the lubricant chamber. As a result, the actuator does not come into contact with lubricant. Reliable sealing of the flow connection in the valve can be achieved in a simple manner. However, alternative types of sealing, for example by way of seal rings or the like, can also be advantageous.

The valve can also be sealed in another way than by a membrane, for example by way of one or a plurality of seal rings or other sealing elements.

According to various embodiments, the closing movement of the valve takes place by way of at least one restoring element. This results in a simple construction. Due to a suitable basic configuration of the restoring element, a rapid closing movement can take place at a desired temperature. In particular, the restoring element keeps the valve in the closed position. In particular, the restoring element does not require any energy to be supplied from the outside, such as current for restoring the valve and/or for keeping the valve in the closed position, for example. For example, the restoring element can be a restoring spring. Alternatively, the valve can have a bistable actuator. The restoring element prevents in particular that the valve can remain in undesirable intermediate positions between the opened and the closed position over comparatively long time. It can be provided that the actuator is only configured to keep the actuating element in a preloaded position or to release the actuating element, and that the actual movement of the valve element to the closed position takes place by virtue of the force of the actuating element.

According to various embodiments, the lubricant pump is driven by the drive motor. According to various embodiments, the lubricant pump is disposed adjacently to a drive shaft of the drive motor. However, it can also be provided that the lubricant pump has a separate pump drive, for example a separate motor. In particular, the drive shaft of the drive motor is coupled to a pump shaft of the lubricant pump by way of a gearbox, in particular a single-stage gearbox.

According to various embodiments, the work apparatus is a chainsaw. However, the present disclosure can also be advantageous for other work apparatuses that have a tool supplied with lubricant.

### BRIEF DESCRIPTION OF DRAWINGS

The invention will now be described with reference to the drawings wherein:

FIG. 1 shows a perspective illustration of a work apparatus configured as a chainsaw, wherein a guide bar and a saw chain of the work apparatus are schematically illustrated and a chain wheel cover of the work apparatus is not illustrated;

FIG. 2 shows a schematic sectional illustration of fragments through the work apparatus from FIG. 1 in the region of a lubricant tank and a lubricant pump;

FIG. 3 shows a schematic illustration of a lubricant supply of the work apparatus;

FIG. 4 shows a sectional illustration through the lubricant pump and a valve of the bark apparatus from FIG. 1; and,

FIG. 5 shows a schematic sectional illustration of an alternative embodiment of a valve.

### DETAILED DESCRIPTION

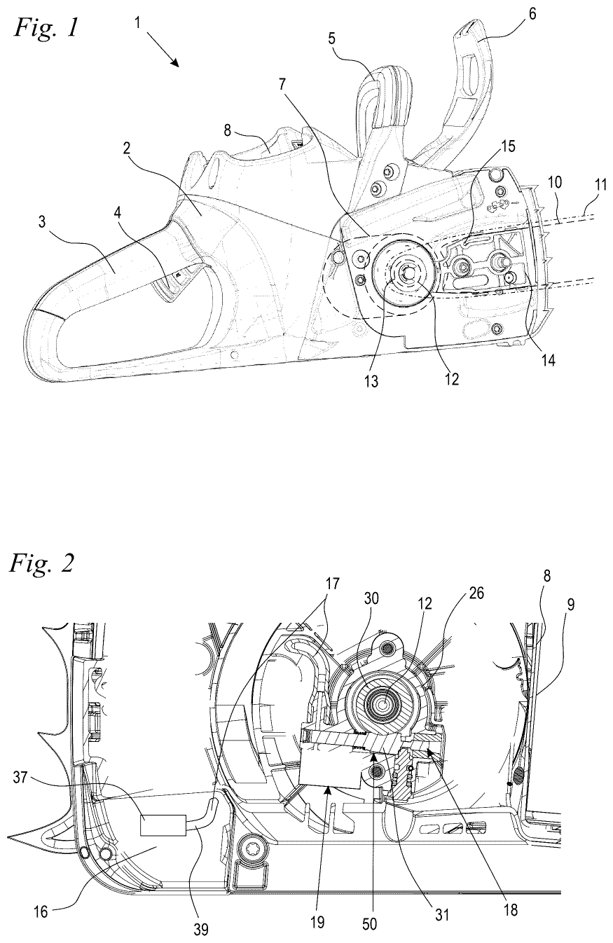

FIG. 1 shows a hand-held work apparatus 1 in a perspective lateral view. The work apparatus 1 in the embodiment is a chainsaw. However, the work apparatus 1 can also be another work apparatus having a lubricant supply, in particular a lubricant supply for a tool of the work apparatus.

The work apparatus 1 has a housing 2 on which handles, in the embodiment a rear handle 3 and a bale handle 5, are fixed. One or a plurality of operator controlled elements 4 which are used for actuating the work apparatus 1 are disposed on the rear handle 3.

The work apparatus 1 has a drive motor 7 which is schematically illustrated in FIG. 1 and is used for driving a tool of the work apparatus 1. The tool in the embodiment is a saw chain 11. The drive motor 7 is disposed in the housing 2. In particular, the drive motor 7 is an electric motor. Alternatively, the drive motor 7 can be an internal combustion engine, in particular a mixture-lubricated internal combustion engine, in particular a two-stroke engine or a mixture-lubricated four-stroke engine.

The work apparatus 1 possesses a battery 9 which is illustrated in fragments and schematically in FIG. 2 and supplies the drive motor 7 with energy. The battery 9 is not illustrated in FIG. 1. Instead, a battery shaft 8 in which the battery 9 is disposed during operation is visible in FIG. 1.

The saw chain 11 is disposed so as to revolve on a guide bar 10. The saw chain 11 and the guide bar 10 are only schematically indicated in FIG. 1. The drive motor 7 has a drive shaft 12. During operation, the saw chain 11 is driven by the drive shaft 12 by way of a drive pinion 13 which is schematically illustrated in FIG. 1.

A hand guard 6 is disposed on the side of the bale handle 5 that faces the saw chain 11. The hand guard 6 can be used for triggering a brake (not illustrated) for the saw chain 11.

The work apparatus 1 has a rail detent 14 on which the guide bar 10 can rest. Additionally, a rail detent plate (not illustrated) can be disposed between the rail detent 14 and the guide bar 10.

For lubricating the saw chain 11, the work apparatus 1 has a lubricant supply 50 (FIG. 2). A lubricant outlet 15 of the lubricant supply 50, by way of which lubricant is guided to the guide bar 10 during the operation of the work apparatus 1, opens out at the rail detent 14. The guide bar 10 has, in particular in its lateral wall in the region of the lubricant outlet 15, an opening (not illustrated) by way of which the lubricant makes its way into a guide groove of the guide bar 10.

FIG. 2 shows the lubricant supply 50 of the work apparatus 1 in detail. The work apparatus 1 includes a lubricant tank 16. In the embodiment, the lubricant tank 16 is of a closed configuration. An overpressure or a vacuum can be created in the lubricant tank 16 in the case of temperature fluctuations.

The lubricant tank 16 in particular does not have any pressure equalization elements such as a pressure relief valve or a vacuum valve.

The lubricant tank 16 is connected to the lubricant outlet 15 by way of a flow connection 17.

In the embodiment, a lubricant line 39, at the end of which a suction head 37 is disposed, protrudes into the lubricant tank 16. Lubricant is conveyed from the lubricant tank 16 to the lubricant outlet 15 by way of the suction head 37 during the operation of the work apparatus 1. The lubricant line 39 forms part of the flow connection 17.

A lubricant pump 18 is disposed in the flow connection 17. The lubricant pump 18 is driven by the drive motor 7. For this purpose, a drive wheel 30 for the lubricant pump 18 is co-rotationally connected to the drive shaft 12.

The lubricant pump 18 has a pump housing 26. A pump shaft 31 of the lubricant pump 18 is mounted in the pump housing 26 so as to be rotatable and movable in a restricted manner in the direction of its longitudinal axis.

The lubricant supply 50 includes a valve 19. The valve 19 is disposed in the flow connection 17 between the lubricant tank 16 and the lubricant pump 18. The valve 19 is a switchable valve. The valve 19 has a completely opened and a closed position. The valve 19 can also have intermediate positions in which the valve 19 is partially opened.

The valve 19 is in particular electrically actuated. In particular, the valve 19 is actuated by current flow through an actuator 20 of the valve 19.

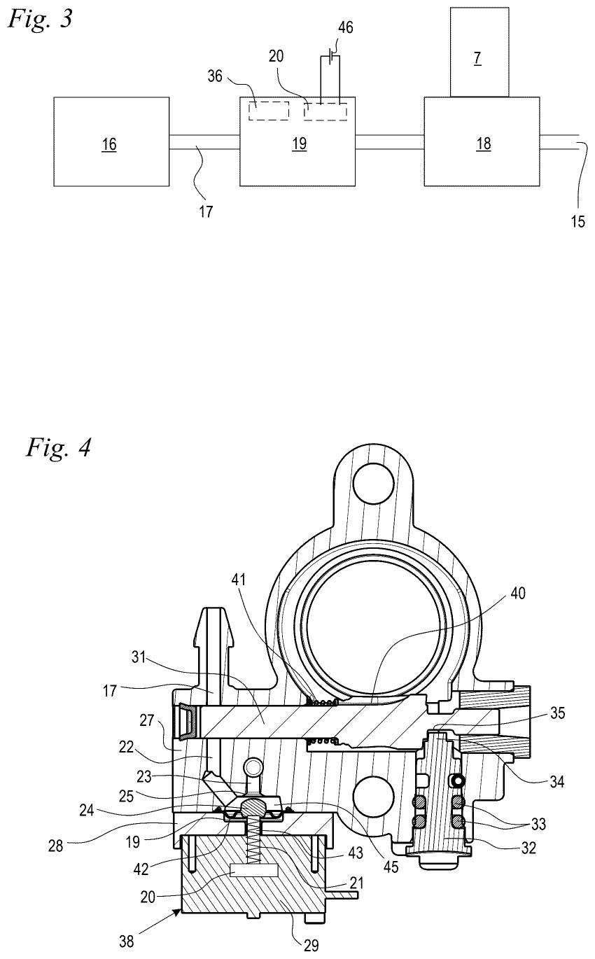

FIG. 3 schematically shows the construction of the lubricant supply 50. The lubricant tank 16 is connected to the lubricant outlet 15 by way of the flow connection 17. The lubricant pump 18 is disposed in the flow connection 17. The valve 19 is disposed in the flow connection 17 between the lubricant tank 16 and the lubricant pump 18. The valve 19 can have a heating element 36 which is schematically illustrated in FIG. 3.

The lubricant pump 18 is in particular disposed on the drive motor 7, as is schematically shown in FIG. 3. The attachment of the lubricant pump 18 to the drive motor 7 is in particular configured to be heat-conducting. A positive heat-conducting attachment of the lubricant pump 18 onto the drive motor 7 can take place by way of metallic contact, for example. In particular, the drive shaft 12 of the drive motor 7 has direct or indirect metallic contact with the pump shaft 31 of the lubricant pump 18, for example by way of a drive wheel 30 yet to be described in more detail hereunder (FIG. 4). A metallic contact between the drive motor 7 and the lubricant pump 18 can additionally or alternatively be formed by direct or indirect contact between metallic housing parts of the drive motor 7 and the lubricant pump 18.

A heat-conducting connection is particularly advantageous when the drive motor 7 is an internal combustion engine. The lubricant pump 18 and/or the valve 19 are in particular connected in a heat-conducting manner to hot components of the drive motor 7, in particular to an exhaust muffler or a cylinder of the drive motor 7.

The valve 19 includes an actuator 20. As shown schematically in FIG. 3, the actuator 20 can be connected to a voltage source 46 and, when the valve 19 is to be opened, be impinged with voltage and heated by the current flow. In particular, the voltage source 46 is connected in such a manner that current can flow at least through part of the actuator 20.

The actuator 20 is in particular composed of metallic material. In particular, the actuator 20 is composed of a shape memory alloy. The actuator 20 can thus be heated by current flow through the actuator 20 or part of the actuator 20.

The lubricant pump 18 is shown in detail in FIG. 4. In the embodiment, a drive wheel 30 is co-rotationally fixed to the drive shaft 12 of the drive motor 7, which drive wheel engages in a toothing 40 on the circumference of the pump shaft 31 and as a result sets the latter in rotation when the drive shaft 12 rotates. The drive motor 7 and the lubricant pump 18 are connected to one another in a heat-conducting manner by way of the drive shaft 12 and the pump shaft 31. Alternatively or additionally, another heat-conducting connection between the drive motor 7 and the lubricant pump 18 can be provided.

The construction of the lubricant pump 18 that is described hereunder is exemplary. The lubricant pump 18 can also be of a different construction. In particular, the lubricant pump 18 has at least one adjustment element projecting from the pump housing 26 for adjusting the amount of lubricant.

For adjusting the amount of lubricant, the lubricant pump 18 in the embodiment has an adjustment pin 32 which protrudes into a groove 35 of the pump shaft 31. The pump shaft 31 is guided in the axial direction on the groove 35. In order to ensure that the wall of the groove 35 securely rests on the adjustment pin 32, the pump shaft 31 is preloaded in the axial direction by a spring 41 in the direction toward the adjustment pin 32. The stroke of the pump shaft 31 is adjustable by way of the adjustment pin 32. The adjustment pin 32 protrudes by way of an eccentric pin 34 into the groove 35. The stroke of the pump shaft 31 can be adjusted by rotating the adjustment pin 32. In order to enable an adjustment of the stroke by the operator, the adjustment pin 32 protrudes from the pump housing 26.

The adjustment pin 32 is sealed in relation to the pump housing 26 by way of seals 33. When the pressure in the lubricant tank 16 increases, lubricant can leak in particular by way of the seals 33 on the adjustment pin 32.

The valve 19 is provided in order to prevent leakage of lubricant from the lubricant tank 16 at the lubricant pump 18 or optionally at other points of leakage. The valve 19 closes in particular when the work apparatus 1 is not in operation. In particular, the valve 19 is configured in such a way that it remains in the closed position without any energy supply, in particular when de-energized.

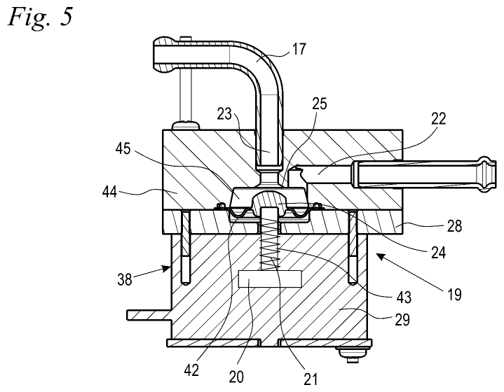

The valve 19 is schematically illustrated in FIG. 5. The valve 19 has a valve housing 38. An inlet channel 22, which is fluidically connected to the lubricant tank 16 by way of the flow connection 17, leads into the valve housing 38. An outlet channel 23, which is fluidically connected to the lubricant pump 18, leads out of the valve 19. The arrangement of the inlet channel 22 and the outlet channel 23 is illustrated by way of example in FIG. 5 and deviates from the arrangement illustrated in the preceding figures.

The valve 19 includes a valve element 24. The actuator 20 is provided for moving the valve element 24. In the configuration of the valve 19 shown, the valve element 24 is held on the actuator 20. In the closed state of the valve 19, the valve 24 rests on a valve seat 25. In the embodiment, the valve seat 25 is formed on the port of the outlet channel 23.

The actuator 20 is a temperature-activated actuator 20. The valve 19 closes in particular when a predefined closing temperature is undershot. In particular, the closing temperature is from 55° C. to 70° C. If the work apparatus 1 is colder than 55° C. at the valve 19, the fluidic connection between the lubricant tank 16 and the lubricant pump 18 is interrupted by the closed valve 19. Lubricant cannot leak from the lubricant tank 16. A restoring element 21, for example a restoring spring, which is schematically illustrated in FIG. 5, is in particular provided for restoring the valve 19 to the opened position. The restoring element 21 enables in particular a short opening time for the valve 19.

In particular, the actuator 20 opens at an opening temperature which is in particular from 55° C. to 70° C.

The actuator 20 is in particular an actuator which is made from a shape memory alloy and changes its shape at a temperature which is predefined by its construction. It can be provided that the actuator 20, when changing its shape, moves the valve element 24 to the valve seat 25 and closes the valve 19. Alternatively, it is provided in particular that the actuator 20 is preloaded by the restoring element 21 and only initiates the movement of the valve element 24 and that the movement of the valve element 24 takes place at least also by virtue of the force of the restoring element 21. Without any supply of energy, the restoring element 21 keeps the valve 19 in the closed position as long as the actuator 20 does not change its shape.

The valve 19 has a valve housing 38. As shown in FIG. 4, part of the valve housing 38 in the embodiment according to FIG. 4 is formed by a base body 27 of the pump housing 26. In the embodiment, the inlet channel 22 and the outlet channel 23 open out in the base body 27 of the pump housing 26. A first housing part 28 of the valve housing 38 is disposed on the base body 27. In the embodiment, a membrane 42 is held, in particularly held clamped, between the base body 27 and the first housing part 28. The valve element 24 is held on the membrane 42. The valve seat 25 is formed on the base body 27 in the embodiment. The membrane 42 delimits a lubricant chamber 45 into which the inlet channel 22 opens out and out of which the outlet channel 23 leads. The lubricant chamber 45 forms part of the flow connection 17.

A second housing part 29 is disposed on the first housing part 28 on the side that faces away from the base body 27. It can be provided that the heating element 36 is integrated on the second housing part 29. Another position of the heating element 36 can also be provided. Alternatively, it can be provided that the actuator 20 per se is heated, in particular by current flow through the actuator 20 when the actuator 20 is composed of electrically conducting material.

An actuation element, in the embodiment an actuation plunger 43, which is connected to the actuator 20, is disposed on the side of the membrane 42 that faces away from the lubricant chamber 45. The actuation plunger 43 is preloaded by a restoring element 21, in the embodiment by a restoring spring, in the direction toward the closed position of the valve 19.

In the embodiment, the actuator 20 is disposed in the second housing part 29. Another arrangement of the components can also be advantageous. The arrangement of the components of the valve 19 is only schematically illustrated in the figures.

It can be provided to adjust the amount of lubricant supplied by way of the lubricant pump 18 during the operation of the work apparatus 1 by way of the valve 19. This can in particular be provided directly after putting the work apparatus 1 into operation. For this purpose, the valve 19 can be opened and closed in cycles, for example. For this purpose, the actuator 20 can be heated in a targeted manner, for example, in particular by corresponding current flow through the actuator 20. Alternatively, the actuator 20 can be kept in an intermediate position between the opened and the closed position. This can take place, for example, by adapting the current flow through the actuator 20. The current flow through the actuator 20 can in particular be adapted in such a way that the actuator 20 does not completely open. In particular, the path traveled by the actuator 20 and thus the position of the valve element 24 is determined by way of the resistance of the actuator 20 that changes by virtue of being heated.

FIG. 5 shows an embodiment of a valve 19 which is formed separately from the lubricant pump 18. The valve 19 possesses a valve housing 38 which includes a first housing part 28, a second housing part 29 and a third housing part 44. The lubricant chamber 45 is disposed in the third housing part 44. The inlet channel 22 and the outlet channel 23 are led in the third housing part 44. The actuator 20 is disposed in the second housing part 29. The membrane 42 is held clamped between the first housing part 28 and the third housing part 44.

Elements of the valve 19 which are not described in more detail in the context of FIG. 5 correspond in particular to those of the preceding embodiment. The same reference signs denote mutually corresponding elements.

Another construction of the valve 19 can also be advantageous.

It is understood that the foregoing description is that of the preferred embodiments of the invention and that various changes and modifications may be made thereto without departing from the spirit and scope of the invention as defined in the appended claims.

1. A work apparatus comprising:
a drive motor;
a tool configured to be driven by said drive motor;
a lubricant tank;
a flow connection for lubricant from said lubricant tank to said tool;
a lubricant pump disposed in said flow connection; and,
a switchable valve disposed in said flow connection between said lubricant tank and said lubricant pump.

2. The work apparatus of claim 1, wherein said switchable valve is electrically actuated.

3. The work apparatus of claim 1, wherein said switchable valve has an actuator made from a shape memory alloy.

4. The work apparatus of claim 3, wherein said actuator is heated for switching.

5. The work apparatus of claim 3, wherein said actuator is heated for switching by directing electric current through at least part of said actuator.

6. The work apparatus of claim 1, wherein said switchable valve is at least partially disposed in a pump housing of said lubricant pump.

7. The work apparatus of claim 6, wherein said switchable valve has a valve housing which is at least partially formed by said pump housing of said lubricant pump.

8. The work apparatus of claim 1, wherein said switchable valve has a membrane on which a valve element of said switchable valve is held; and, said membrane delimits a lubricant chamber through which said flow connection leads.

9. The work apparatus of claim 1, wherein a closing movement of said switchable valve takes place by way of at least one restoring element.

10. The work apparatus of claim 1, wherein said lubricant pump is driven by said drive motor.

11. The work apparatus of claim 1, wherein the work apparatus is a chainsaw.
